(19) United States
(12) Patent Application Publication
(10) Pub. No.: US 2009/0299755 A1
(43) Pub. Date: Dec. 3, 2009

(54) Method for Post-Processing a Signal in an Audio Decoder

(75) Inventors: Stéphane Ragot, Lannion (FR); Cyril Guillaume, Beaurepaire (FR)

Correspondence Address: COHEN, PONTANI, LIEBERMAN & PAVANE LLP, 551 FIFTH AVENUE, SUITE 1210, NEW YORK, NY, 10176, US

(73) Assignee: FRANCE TELECOM, Paris (FR)

(21) Appl. No.: 12/225,462

(22) PCT Filed: Mar. 20, 2007
(86) PCT No.: PCT/FR2007/050959

§ 371 Date: Jun. 22, 2009

(30) Foreign Application Priority Data
Mar. 20, 2006 (FR) 0650954

(51) Int. Cl. G10L 19/00; G10L 19/02

(52) U.S. Cl. 704/500; 704/E19.01

(57) ABSTRACT

A method of post-processing in an audio decoder a signal reconstructed by time and frequency shaping (805, 807) of an excitation signal obtained from an estimated parameter in a first frequency band, said time and frequency shaping being effected at least on the basis of a time envelope and a received and decoded (801, 802) frequency envelope in a second frequency band. The method includes, after said shaping (805, 807), the steps of comparing the amplitude of said reconstructed signal to said received and decoded time envelope and, in the event of exceeding a threshold that is function of said time envelope, applying amplitude compression to said reconstructed signal. Also disclosed is a post-processing module adapted to execute the method, and an audio decoder.

The present invention relates to a method of post-processing a signal in an audio decoder.

The invention finds a particularly advantageous application to transmitting and storing digital signals such as audio-frequency signals: speech, music, etc.

There are various techniques for digitizing and compressing an audio-frequency speech, music, etc. signal. The commonest methods are “waveform coding” methods such as PCM and ADPCM coding, “parametric analysis by synthesis coding” methods, such as code excited linear prediction (CELP) coding, and “sub-band or transform perceptual coding” methods.

These classic techniques for coding audio-frequency signals are described for example in “Vector Quantization and Signal Compression”, A. Gersho and R. M. Gray, Kluwer Academic Publisher, 1992, and “Speech Coding and Synthesis”, B. Kleijn and K. K. Paliwal, Editors, Elsevier, 1995.

In conventional speech coding, the coder generates a bit stream at fixed bit rate. This fixed bit rate constraint simplifies implementation and use of the coder and the decoder (codec). Examples of such systems are: ITU-T G.711 coding at 64 kbps, ITU-T G.729 coding at 8 kbps, and the GSM-EFR system at 12.2 kbps.

In some applications, such as mobile telephones and voice over IP, it is preferable to generate a variable bit rate bit stream, the bit rate values being taken from a predefined set.

Multiple bit rate coding techniques more flexible than fixed bit rate coding include:
multimode coding controlled by the source and/or the channel, as used in the AMR-NB, AMR-WB, SMV, and VMR-WB systems;
hierarchical (“scalable”) coding, which generates a bit stream referred to as hierarchical because it includes a core bit rate and one or more enhancement layers. The 48 kbps, 56 kbps and 64 kbps G.722 system is a simple example of bit rate scalable coding. The MPEG-4 CELP codec is bit rate and bandwidth scalable; other examples of such coders can be found in papers by B. Kovesi, D. Massaloux, A. Sollaud, “A Scalable Speech and Audio Coding Scheme with Continuous Bit rate Flexibility”, ICASSP 2004, and by H. Taddei et al., “A Scalable Three Bit rate (8, 14.2 and 24 kbps) Audio Coder”, 107^{th} Convention AES, 1999;
multiple description coding.

The invention is more particularly concerned with hierarchical coding.

The basic concept of hierarchical audio coding is illustrated in the paper by Y. Hiwasaki, T. Mori, H. Ohmuro, J. Ikedo, D. Tokumoto and A. Kataoka, “Scalable Speech Coding Technology for High-Quality Ubiquitous Communications”, NTT Technical Review, March 2004, for example. The bit stream includes a base layer and one or more enhancement layers. The base layer is generated by a codec known as the “core codec” at a fixed low bit rate, guaranteeing a minimum coding quality; this layer must be received by the decoder to maintain an acceptable level of quality. The enhancement layers are used to enhance quality; they may not all be received by the decoder. The main benefit of hierarchical coding is that it enables the bit rate to be adapted simply by truncating the bit stream. The possible number of layers, i.e. the possible number of truncations of the bit stream, defines the coding granularity: the expression “strong granularity” is used if the bit stream includes few layers (of the order of two to four layers), with increments of the order of 4 kbps to 8 kbps; the expression “fine granularity coding” refers to a large number of layers with an increment of the order of 1 kbps.

The invention relates more particularly to bit rate and bandwidth scalable coding techniques using a CELP core coder in the telephone band and one or more wideband enhancement layers. Examples of such systems are given in the above-mentioned paper by H. Taddei et al., with strong granularity at 8 kbps, 14.2 and 24 kbps, and in the above-mentioned paper by B. Kovesi et al. with fine granularity at 6.4 kbps to 32 kbps.

In 2004 the ITU-T launched a draft standard for a core hierarchical coder. This G.729EV standard (EV standing for “embedded variable bit rate”) is an add-on to the well-known G.729 coder standard. The objective of the G.729EV standard is to obtain a G.729 core hierarchical coder producing a signal in a band from the narrow band (300 hertz (Hz)-3400 Hz) to the wide band (50 Hz-7000 Hz) at a bit rate from 8 kbps to 32 kbps for conversation services. This coder is inherently capable of interworking with G.729 plant, which ensures compatibility with existing voice over IP plant.

In response to this draft, there has in particular been proposed a three-layer coding system, comprising cascade CELP coding at 8 kbps-12 kbps, followed by parametric band expansion at 14 kbps, and then transform coding at 14 to 32 kbps. This coder is known as the ITU-T SG16/WP3 D214 coder (ITU-T, COM 16, D214 (WP 3/16), “High level description of the scalable 8 kbps-32 kbps algorithm submitted to the Qualification Test by Matsushita, Mindspeed and Siemens”, Q.10/16, Study Period 2005-2008, Geneva, 26 Jul.-5 Aug. 2005).

The band expansion concept relates to coding the high band of a signal. In the context of the invention, the input audio signals are sampled at 16 kHz over a usable band from 50 Hz to 7000 Hz. For the ITU-T SG16/WP3 D214 coder referred to above, the high band typically corresponds to frequencies in the range 3400 Hz to 7000 Hz. This band is coded using a band expansion technique based on extracting time and frequency envelopes in the coder, which envelopes are then applied in the decoder to a synthesized excitation signal reconstructed in the high band from parameters estimated in the low band (in the range 50 Hz to 3400 Hz), sampled at 8 kHz. The low band is referred to below as the “first frequency band” and the high band as the “second frequency band”.

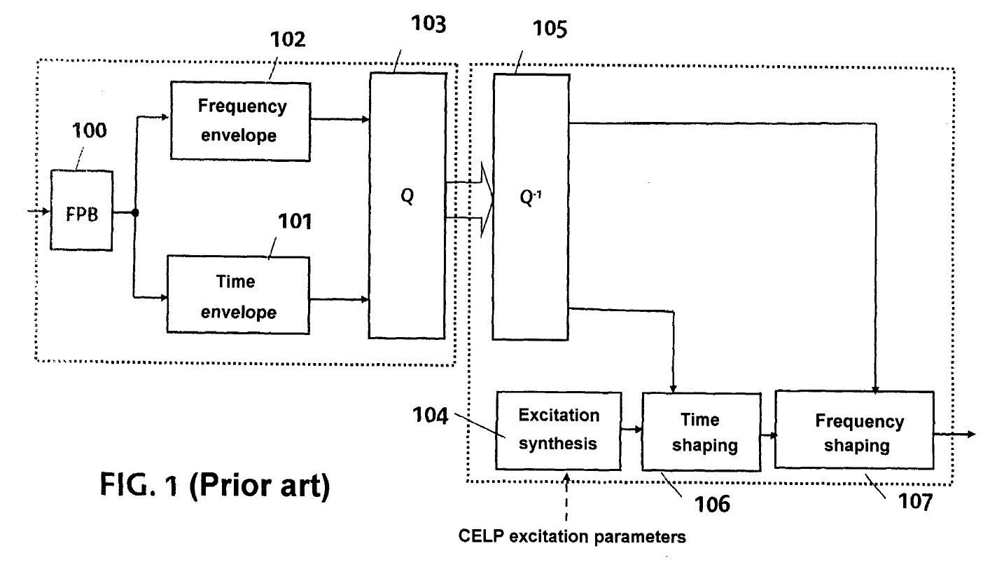

FIG. 1 is a diagram of this band expansion technique.

In the coder, the high-frequency components of the original signal at 3400 Hz to 7000 Hz are isolated by a band-pass filter 100. The time and frequency envelopes of the signal are then calculated by the modules 101 and 102, respectively. The envelopes are conjointly quantized at 2 kbps in the block 103.

In the decoder, synthetic excitation is reconstructed from parameters of the cascade CELP decoder by the reconstruction module 104. The time and frequency envelopes are decoded by the inverse quantizer block 105. The synthesized excitation signal coming from the reconstruction module 104 is then shaped by a scaling module 106 (time envelope) and by a filter module 107 (frequency envelope).

The band expansion mechanism that has just been described with reference to the ITU-T SG16/WP3 D214 codec therefore relies on forming a synthesized excitation signal by means of time and frequency envelopes. However, with no coupling between excitation and shaping, applying this kind of model is difficult and causes artifacts in the form of localized “clicks” that are very audible because the upper amplitude limit is greatly exceeded.

Thus the technical problem to be solved by the subject matter of the present invention is to propose a method of post-processing in an audio decoder a signal reconstructed by time and frequency shaping an excitation signal obtained from a parameter estimated in a first frequency band, which method should prevent artifacts induced by shaping the synthesized excitation signal, said time and frequency shaping being carried out on the basis of a time envelope and a received and decoded frequency envelope in a second frequency band.

The solution according to the present invention to the stated technical problem consists in said method including the steps of comparing the amplitude of said reconstructed signal to said received and decoded time envelope and, in the event of exceeding a threshold that is function of said time envelope, applying amplitude compression to said reconstructed signal.

Thus the method of the invention compensates the absence of adequate coupling between excitation and shaping by using amplitude compression for post-processing the audio signal supplied by the decoder in the second frequency band (high band).

In one embodiment, said amplitude compression consists in applying linear attenuation to the amplitude of said signal if said amplitude is greater than a triggering threshold that is a function of said received and decoded time envelope.

Note that, in addition to limiting the amplitude of the signal and therefore the artifacts associated with high amplitudes, the method of the invention has the advantage of being adaptive in the sense that the triggering threshold is variable because it tracks the value of the received and decoded time envelope.

The invention also relates to a computer program including program code instructions for executing the post-processing method of the invention when said program is executed on a computer.

The invention further relates to a module for post-processing in an audio decoder a signal reconstructed by shaping an excitation signal obtained from an estimated parameter in a first frequency band, said time and frequency shaping being effected on the basis of a time envelope and a received and decoded frequency envelope in a second frequency band, the module being noteworthy in that it includes a comparator for comparing the amplitude of said reconstructed signal to said received and decoded time envelope and amplitude compression means adapted, in the event of a positive comparison result, to apply amplitude compression to said reconstructed signal.

The invention finally relates to an audio decoder including a module for estimating at least a parameter of an excitation signal in a first frequency band, a module for reconstructing an excitation signal from said parameter, a module for decoding a time envelope in a second frequency band, a module for decoding a frequency envelope in a second frequency band, a module for time shaping said excitation signal at least by means of said decoded time envelope, and a module for frequency shaping said excitation signal at least by means of said decoded frequency envelope, noteworthy in that said decoder includes a post-processing module according to the invention.

The following description with reference to the appended drawings, provided by way of non-limiting example, clearly explains in what the invention consists and how it can be reduced to practice.

FIG. 1 is a diagram of a prior art high-band coding-decoding stage;

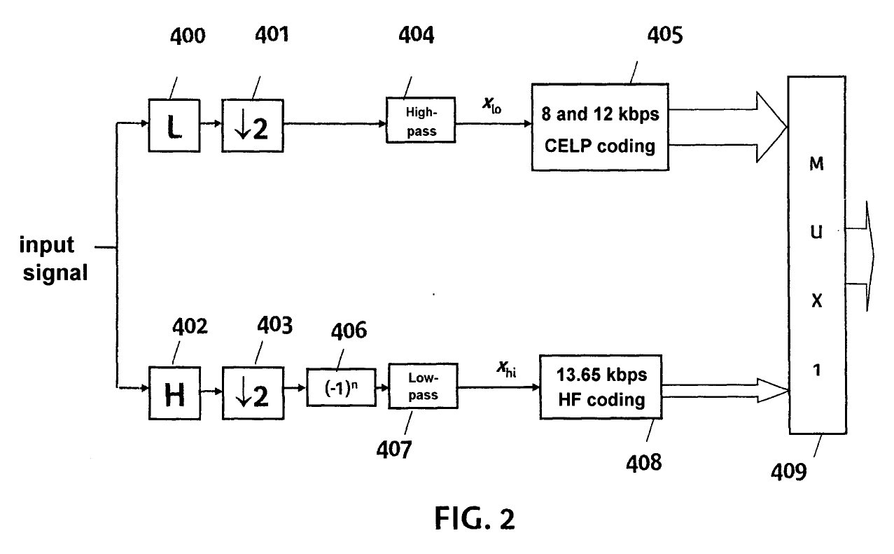

FIG. 2 is a high-level diagram of an 8 kbps, 12 kbps, 13.65 kbps hierarchical audio coder;

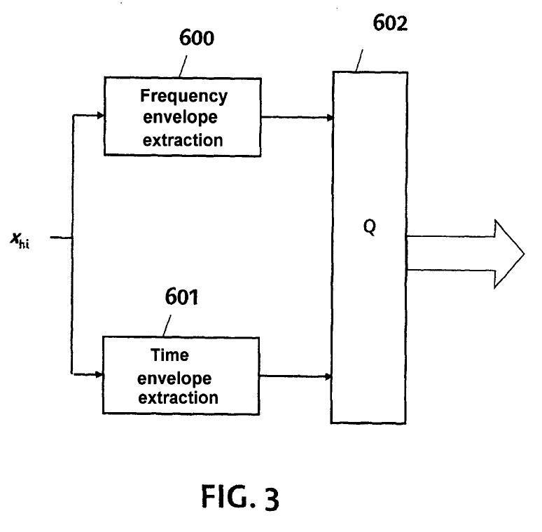

FIG. 3 is a diagram of the high-band coder for the 13.65 kbps mode of the FIG. 2 coder;

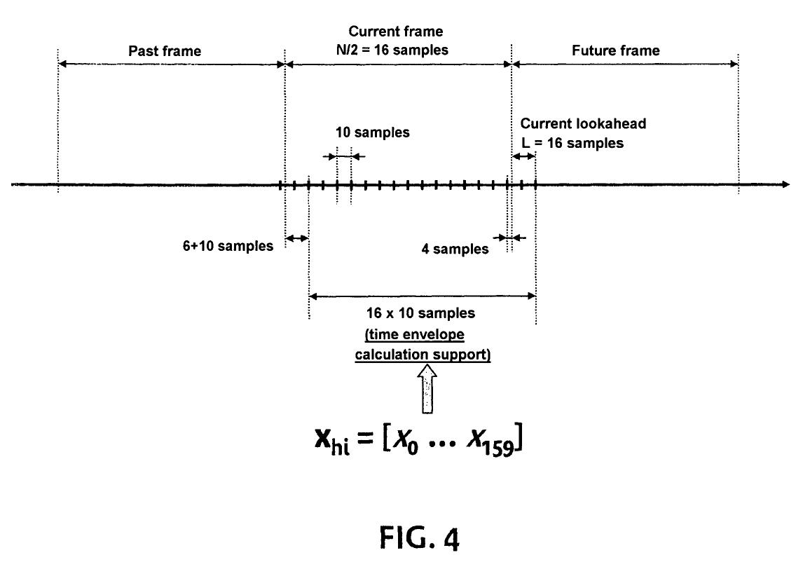

FIG. 4 is a diagram showing the division into frames effected by the high-band coder from FIG. 3;

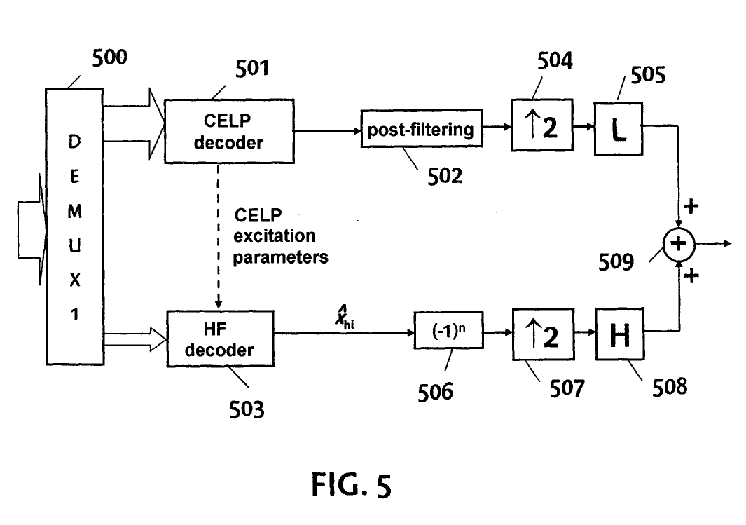

FIG. 5 is a high-level diagram of an 8 kbps, 12 kbps, 13.65 kbps hierarchical audio decoder associated with the coder from FIG. 2;

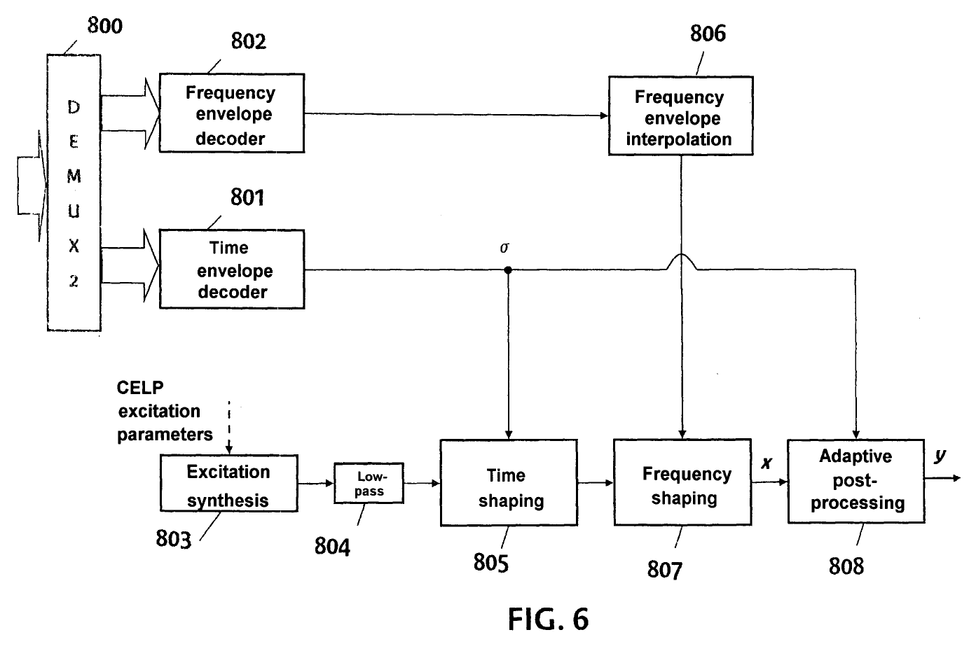

FIG. 6 is a diagram of a high-band decoder for the 13.65 kbps mode of the decoder from FIG. 5;

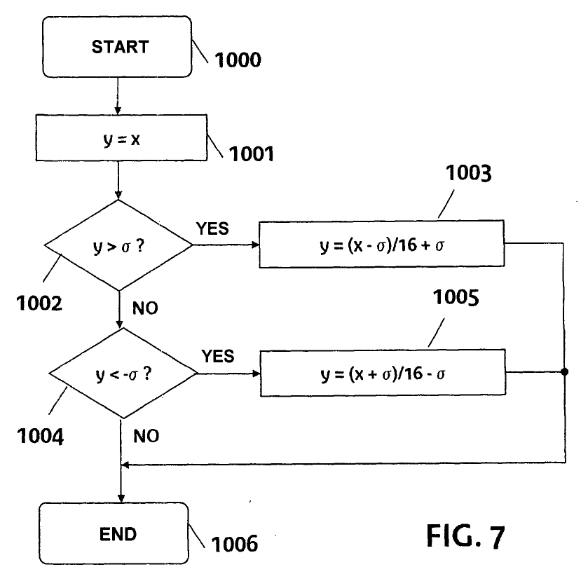

FIG. 7 is a flowchart of a first embodiment of an amplitude compression function;

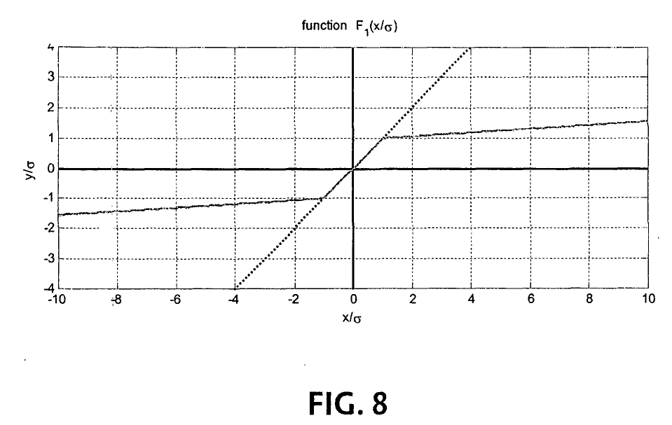

FIG. 8 is a graph of the amplitude compression function from FIG. 7;

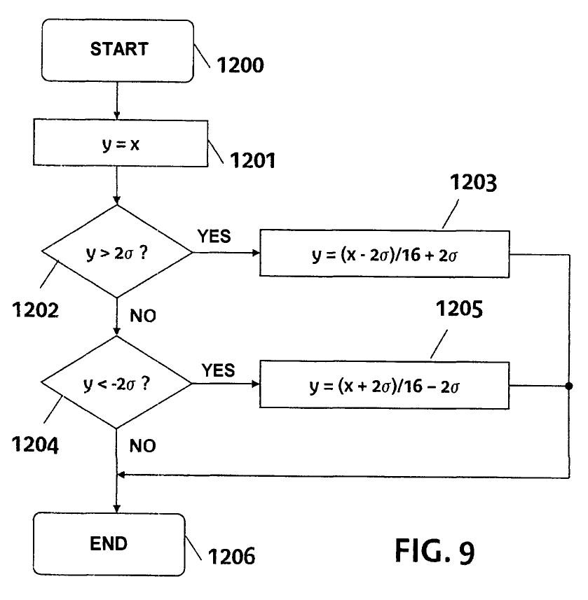

FIG. 9 is a flowchart of a second embodiment of an amplitude compression function;

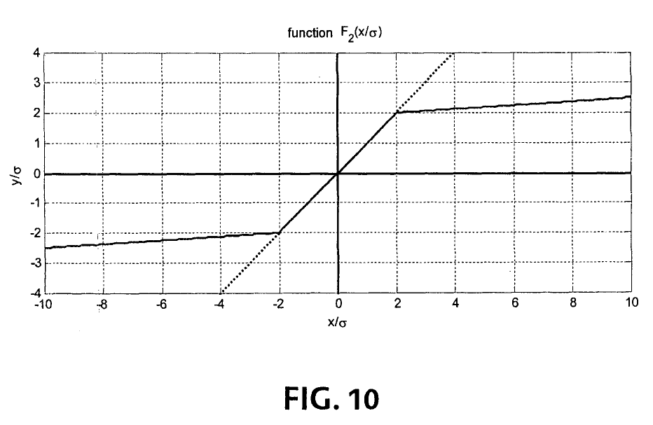

FIG. 10 is a graph of the amplitude compression function from FIG. 9.

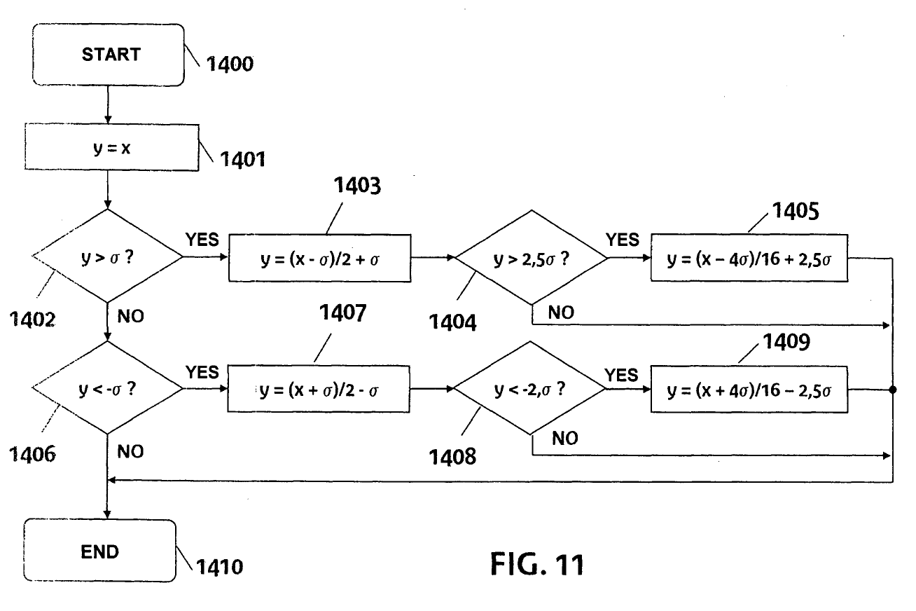

FIG. 11 is a flowchart of a third embodiment of an amplitude compression function;

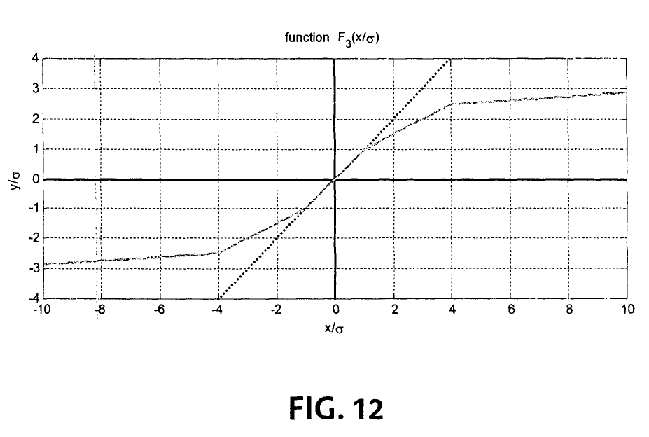

FIG. 12 is a graph of the amplitude compression function from FIG. 11.

It should be remembered that the general context of the invention is sub-band hierarchical audio coding and decoding at three bit rates: 8 kbps, 12 kbps and 13.65 kbps. In practice, the coder always operates at the maximum bit rate of 13.65 kbps and the decoder can receive the 8 kbps core and one or both 12 kbps or 13.65 kbps enhancement layers.

FIG. 2 is a diagram of the hierarchical audio coder.

The wide band input signal sampled at 16 kHz is first divided into two sub-bands by filtering it using the QMF (quadrature mirror filter bank) technique. The first frequency band (low band), in the range 0 to 4000 Hz, is obtained by low-pass (L) filtering 400 and decimation 401 and the second frequency band (high band), in the range 4000 Hz to 8000 Hz, is obtained by high-pass (H) filtering 402 and decimation 403. In a preferred embodiment, the L and H filters are of length 64 and conform to those described in the paper by J. Johnston, “A filter family designed for use in quadrature mirror filter banks”, ICASSP, vol. 5, pp. 291-294, 1980.

The low band is pre-processed by a high-pass filter 404 to eliminate components below 50 Hz before 8 kbps and 12 kbps narrow-band CELP coding 405. This high-pass filtering takes account of the fact that the wide band is defined as covering the range 50 Hz-7000 Hz. In one embodiment, the narrow-band CELP coder is the ITU-T SG16/WP3 D135 coder (ITU-T, COM 16, D135 (WP 3/16), “France Telecom G.729EV Candidate: High level description and complexity evaluation”, Q.10/16, Study Period 2005-2008, Geneva, 26 July - 5 August 2005); this effects cascade CELP coding including modified G.729 8 kbps first stage coding (ITU-T Recommendation G.729, Coding of Speech at 8 kbps using Conjugate Structure Algebraic Code Excited Linear Prediction (CS-ACELP), March 1996) with no pre-processing filter and 12 kbps second stage coding using an additional fixed CELP dictionary. CELP coding determines the parameters of the excitation signal in the low band.

The high band first undergoes anti-aliasing processing 406 to compensate aliasing caused by the high-pass filtering 402 in conjunction with the decimation 403. The high band is then pre-processed by a low-pass filter 407 to eliminate components in the high band in the range 3000 Hz to 4000 Hz, i.e. components in the original signal in the range 7000 Hz to 8000 Hz. This is followed by band expansion (high-band coding) 408 at 13.65 kbps.

The bit streams generated by the coding modules 405 and 408 are multiplexed and structured as a hierarchical bit stream in the multiplexer 409.

Coding is effected on blocks of 320 samples (20 millisecond (ms) frames). The hierarchical coding bit rates are 8 kbps, 12 kbps and 13.65 kbps.

FIG. 3 shows the high band coder 408 in more detail. Its principle is similar to the parametric band expansion of the ITU-T SG16/WP3 D214 coder.

The high-band signal xₕᵢ is coded into frames of N/2 samples, where N is the number of samples of the original wide-band frame and the division by 2 is the result of decimating the high band by a factor of 2. In a preferred embodiment, N/2=160, which corresponds to 20 ms frames at a sampling frequency of 8 kHz. For each frame, i.e. every 20 ms, the modules 600 and 601 extract time and frequency envelopes as in the ITU-T SG16/WP3 D214 coder. These envelopes are then conjointly quantized in the block 602.

An brief explanation of the frequency envelope extraction effected by the module 600 follows.

Because spectral analysis uses a time window centered on the current frame that overlaps the future frame, this operation needs “future” samples, usually called the “lookahead”. In a preferred embodiment, the high-band lookahead is set at L=16 samples, i.e. 2 ms. Frequency envelope extraction can be carried out in the following manner, for example:
calculation of the short-term spectrum with windowing of the current frame and lookahead and discrete Fourier transformation;
division of the spectrum into sub-bands;
calculation of the short-term energy of the sub-bands and conversion to an rms value.

The frequency envelope is therefore defined as the rms value of each of the sub-bands of the signal xₕᵢ.

Time envelope extraction by the module 601 is explained next with reference to FIG. 4, which shows in more detail the temporal division of the signal xₕᵢ.

Each 20 ms frame consists of 160 samples:

Xₕᵢ=[x₀ x₁ . . . x₁₅₉]

The last 16 samples of xₕᵢ constitute the lookahead for the current frame.

The time envelope of the current frame is calculated in the following manner:
division of xₕᵢ into 16 sub-frames of 10 samples;
calculation of the energy of each of the sub-frames and conversion to an rms value.

The time envelope is therefore defined as the rms value of each of the 16 sub-frames of the signal xₕᵢ.

FIG. 5 represents a hierarchical audio decoder associated with the coder just described with reference to FIGS. 2 and 3.

The bits defining each 20 ms frame are demultiplexed by the demultiplexer 500. The bit stream of the 8 kbps and 12 kbps layers is used by the CELP decoding module 501 to generate the synthesized parameters of the excitation signal in the low band in the range 0 to 4000 Hz. The low-band synthesized speech signal is then post-filtered by the block 502.

The portion of the bit stream associated with the 13.65 kbps layer is decoded by the band expansion module 503.

The wide-band output signal sampled at 16 kHz is obtained by means of the synthesized QMF filter bank 504, 505, 507, 508 and 509, incorporating anti-aliasing 506.

The high-band decoder 503 from FIG. 5 is described in more detail with reference to FIG. 6.

This decoder uses the high-band synthesis principle described for the FIG. 1 coder, but with two modifications: it includes a frequency envelope interpolation module 806 and a post-processing module 808. The frequency envelope interpolation and post-processing modules enhance the quality of coding in the high band. The module 806 effects interpolation between the frequency envelope of the preceding frame and the frequency envelope of the current frame so that this envelope evolves every 10 ms, rather than every 20 ms.

The FIG. 6 high-band decoder in the demultiplexer 800 demultiplexes the parameters received in the bit stream and decodes the time and frequency envelope information in the decoding modules 801 and 802. A synthesized excitation signal is generated in a reconstruction module 803 from the CELP excitation parameters received by the 8 kbps and 12 kbps layers. This excitation is filtered in the low-pass filter 804 to retain only the frequencies in the range 0 to 3000 Hz that correspond to the 4000 Hz to 7000 Hz band of the original signal. As in the FIG. 1 coder, the synthesized excitation signal is shaped by the modules 805 and 807:
the output of the temporal shaping module 805 ideally has an rms value for each of the sub-frames that corresponds to the decoded time envelope; the module 805 therefore corresponds to the application of a gain that is adaptive in time;
the output of the frequency shaping module 807 ideally has an rms value for each of the sub-bands that corresponds to the decoded frequency envelope; the module 807 can be implemented by means of a filter bank or a transform with overlap.

The signal x resulting from shaping the excitation signal is processed by the post-processing module 808 to obtain the reconstructed high band y.

The post-processing module 808 is described in more detail next.

The post-processing effected by the module 808 applies amplitude compression to the signal x coming from the frequency-shaping module 807 to limit the amplitude of the signal and thus prevent artifacts that could otherwise be produced because of the lack of coupling between excitation and shaping.

The output signal y of the post-processing module 808 is written in the following form, in which σ designates the decoded time envelope:

y=C(x)=σ.F(x/σ)

The properties of the post-processing proposed by the invention are as follows:
it acts instantaneously, i.e. sample by sample, without generating any processing delay;
the triggering threshold for the amplitude compression is given by the time envelope as decoded by the time envelope decoding module 801; by definition, σ≧0;
the post-processing is adaptive because the value of a changes in each sub-frame of 10 samples, i.e. every 1.25 ms;
the decoded time envelope for the current frame corresponds to a shift of 2 ms, i.e. 16 samples, as shown in FIG. 4. Thus the adaptive post-processing stores the rms value of the two sub-frames associated with the lookahead: these two sub-frames correspond to the two sub-frames at the start of the current frame.

The FIG. 7 flowchart shows a first post-processing compression function C₁(x). The start and end of the calculations are identified by the blocks 1000 and 1006. The output value y is first initialized to x (block 1001). Two tests are then effected (blocks 1002 and 1004) to verify if y is in the range [−σ, σ]. Three situations are possible:
if y is in the range [−σ, σ], the calculation of y is complete: y=x and C₁(x)=x; F₁(x/σ)=x/σ;
if y>σ, its value is modified as defined in the block 1003; the difference between y and +σ is attenuated by a factor of 16;
if y<−σ, its value is modified as defined in the block 1005; the difference between y and −σ is attenuated by a factor of 16.

To show clearly how the operation y=C₁(x) functions, FIG. 8 shows the curve of y/σ as a function of x/σ. The data is normalized by a to make the input/output characteristic independent of the value of σ. This normalized characteristic is denoted F₁(x/σ); consequently: C₁(x)=σF₁(x/σ).

FIG. 8 shows clearly that the function C₁(x) effects symmetrical amplitude compression with a triggering threshold set at +/−σ. To be more precise, the slope of F₁(x/σ) is 1 in the range [−1, +1] and 1/16 elsewhere. In an equivalent way, the slope of C₁(x) is 1 in the range [−σ, +σ] and 1/16 elsewhere.

Two variants of post-processing are described with reference to FIGS. 9 to 12. The corresponding functions are respectively denoted C₂ (x) and C₃ (X).

The post-processing C₂ (x) shown in FIGS. 9 and 10 is identical to C₁ (x) but with a triggering threshold value changed from +/−σ to +/−2σa. Thus the slope of C₂ (x) is 1 in the range [−2σ, +2σ] and 1/16 elsewhere.

The post-processing C₃(x) is a more developed variant of C₁ (x), in which amplitude compression is effected in two successive steps. As shown in FIG. 11, the triggering range is still set at [−σ, +σ] (blocks 1402 and 1406), but in contrast the value of y is attenuated by only a factor of ½, unless the value of y as modified by the blocks 1403 and 1407 is outside the range [−2.5 σ, +2.5 σ], in which case the value of y is again modified by the blocks 1405 and 1409. The functioning of C₃ (x) is shown in FIG. 12, in which it can be seen that the slope of C₃ (x) is:
1/16 in the ranges [−∞, −4σ] and [4σ, +∞];
½ in the ranges [−4σ, −σ] and [σ, 4σ]; and
1 in the range [−σ, +σ].

1. A method of post-processing in an audio decoder a signal reconstructed by time and frequency shaping (805, 807) of an excitation signal obtained from an estimated parameter in a first frequency band, said time and frequency shaping being effected at least on the basis of a time envelope and a received and decoded (801, 802) frequency envelope in a second frequency band, wherein said method includes, after said shaping (805, 807), the steps of comparing the amplitude of said reconstructed signal to said received and decoded time envelope (σ) and, in the event of exceeding a threshold that is function of said time envelope, applying amplitude compression to said reconstructed signal.

2. The method according to claim 1, wherein said received and decoded time envelope (σ) is defined as an rms value for each of the sub-frames of the signal in the second frequency band (xₕᵢ).

3. The method according to claim 1, wherein said amplitude compression comprises applying linear attenuation to the amplitude of said reconstructed signal if said amplitude is greater than a triggering threshold that is a function of said received and decoded time envelope (σ).

4. The method according to claim 1, wherein said amplitude compression is effected in accordance with a law of linear attenuation by fragments triggered by triggering thresholds as a function of said received and decoded time envelope (σ).

5. The computer program including program code instructions for executing the post-processing method according to claim 1, when said program is executed in a computer.

6. A module for post-processing in an audio decoder a signal reconstructed by time and frequency shaping of an excitation signal obtained from an estimated parameter in a first frequency band, said time and frequency shaping being effected at least on the basis of a time envelope and a received and decoded frequency envelope in a second frequency band, wherein said post-processing module (808) includes a comparator for comparing the amplitude of said reconstructed signal to said received and decoded time envelope (σ) and amplitude compression means adapted, in the event of exceeding a threshold that is function of said time envelope, to apply amplitude compression to said reconstructed signal.

7. An audio decoder including a module (501) for estimating a parameter of an excitation signal in a first frequency band, a module (803) for reconstructing an excitation signal from said parameter, a module (801) for decoding a received and decoded time envelope (σ) in a second frequency band, a module (802) for decoding a frequency envelope in a second frequency band, a module (805) for time shaping said excitation signal at least by means of said received and decoded time envelope (σ), and a module (807) for frequency shaping said excitation signal at least by means of said decoded frequency envelope, wherein said decoder further includes a post-processing module (808) according to claim 6.

8. A decoder according to claim 7, comprising a frequency envelope interpolation module (806).
